(19) United States
(12) Patent Application Publication
(10) Pub. No.: US 2025/0280027 A1
(43) Pub. Date: Sep. 4, 2025

(54) SECURITY RATING & INCIDENT RISK SCORING FOR ATTACK SURFACE MANAGEMENT

(71) Applicant: Palo Alto Networks, Inc., Santa Clara, CA (US)

(72) Inventors: Xavier Mignot, San Francisco, CA (US); Madhuresh Anur Gurugopal Raju, Fremont, CA (US); David Lu, Sunnyvale, CA (US); Richa Avasthi, Moraga, CA (US); Irina Ilascu Renteria, New York, NY (US); Skyler Onken, Birmingham, AL (US); Aaron Isaksen, Brooklyn, NY (US); Gregory David Heon, San Francisco, CA (US)

(21) Appl. No.: 18/592,040

(22) Filed: Feb. 29, 2024

(51) Int. Cl. H04L 9/40

(52) U.S. Cl. CPC H04L 63/1433

(57) ABSTRACT

A method, system, and device for identifying network incident risk. The method includes (i) determining a set of incident scores for a set of incidents on a network, (ii) generating a security rating for an attack surface for the network, wherein the security rating is an aggregation of the incident risk scores associated with a subset of risks on the network, and (iii) providing the security rating.

### BACKGROUND OF THE INVENTION

In today's interconnected digital landscape, securing network infrastructure against cyber threats is paramount for organizations across various industries. Traditional methods for assessing network security posture often rely on static representations and manual analysis, which may overlook dynamic threats and vulnerabilities. Existing solutions may lack the ability to provide actionable insights into the evolving attack surface, making it challenging for organizations to effectively manage security risks.

Existing solutions for representing the security posture of a network do not allow a user to effectively prioritize risks to the network. For example, existing solutions provide an overwhelming volume of alerts that are to be manually triaged by security operations and network administrators. As another example, existing solutions make it difficult to discern the business impact of a particular risk to the network security posture or attack surface.

### BRIEF DESCRIPTION OF THE DRAWINGS

Various embodiments of the invention are disclosed in the following detailed description and the accompanying drawings.

FIG. 1 is a block diagram of an environment for assessing a network attack surface according to various embodiments.

FIG. 2 is a block diagram of a system to assess a network attack surface according to various embodiments.

FIG. 3A is an illustration of user interface configured to visualize information pertaining to a security rating for a particular attack surface according to various embodiments.

FIG. 3B is an illustration of user interface configured to visualize information pertaining to a security rating for a particular attack surface according to various embodiments.

FIG. 4 is an illustration of user interface configured to visualize information pertaining to an incident identified for a particular attack surface according to various embodiments.

FIG. 5 is a flow diagram of a method for identifying network incident risk according to various embodiments.

FIG. 6 is a flow diagram of a method for remediating an incident risk identified for a particular attack surface according to various embodiments.

FIG. 7 is a flow diagram of a method for remediating an incident risk identified for a particular attack surface according to various embodiments.

FIG. 8 is a flow diagram of a method for determining an incident risk score for a set of incidents according to various embodiments.

FIG. 9 is a flow diagram of a method for obtaining a security rating for a particular attack surface according to various embodiments.

FIG. 10 is a flow diagram of a method for evaluating a security rating for a particular attack surface according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, an attack surface includes the sum of all possible points where an attacker can try to enter or extract data from a system such as a computer network, an application, or a software component. The attack surface represents the vulnerabilities, entry points, and potential attack vectors that could be exploited by malicious actors. Common components that contribute to the attack surface in a network security context, include:
Network Protocols: Various protocols used for communication within the network can introduce vulnerabilities if not properly secured. For example, open ports, insecure configurations, or outdated protocols can expose the network to potential attacks.
Software Components: This includes operating systems, applications, and services running on network devices. Vulnerabilities in software can be exploited by attackers to gain unauthorized access, execute arbitrary code, or disrupt services.
User Accounts and Credentials: Weak passwords, insecure authentication mechanisms, and improper access controls can provide avenues for attackers to compromise user accounts and gain unauthorized access to the network.
External Interfaces: Interfaces that connect the network to external entities such as the internet, partner networks, or third-party services can introduce risks if not properly secured. For example, insecure APIs or untrusted connections can be exploited by attackers to infiltrate the network.
Physical Infrastructure: Physical access to network infrastructure components such as routers, switches, and servers can also pose a security risk. Physical tampering or unauthorized access to hardware can compromise the integrity and confidentiality of the network.

By understanding and analyzing the attack surface, organizations can implement appropriate security measures to mitigate risks and protect their network infrastructure from potential threats. This may include deploying firewalls, intrusion detection systems, access controls, encryption mechanisms, and regularly updating software to address known vulnerabilities.

In some embodiments, the system is configured to evaluate or analyze the attack surface for a network, such as for cybersecurity applications. The evaluating or analyzing the attack surface involves identifying, assessing, and understanding the various potential vulnerabilities and entry points (e.g., incidents) that could be exploited by attackers. The system can implement one or more of the following methods and techniques to evaluate the attack surface:
Asset Inventory: The system identifies and catalogs all assets within the network, including hardware devices, software applications, and data repositories. The system then creates a comprehensive understanding of what assets needs protection or are vulnerable.
Network Mapping: The system can use network mapping tools to discover and visualize the network topology, including devices, servers, and their interconnections. Understanding the network layout helps the system to identify potential entry points and attack paths.
Vulnerability Scanning: The system can conduct vulnerability scans using automated tools to identify known vulnerabilities in network devices, operating systems, and applications. The system can use the vulnerability scans to help identify weaknesses that could be exploited by attackers.
Penetration Testing: The system can perform penetration testing or ethical hacking to simulate real-world attacks and assess the effectiveness of existing security controls. The penetration testing or ethical hacking may be automatically performed, such as by a trained service, or manually performed by subject matter experts, or a combination of automatic and manual implementation. The penetration testers attempt to exploit vulnerabilities in the network to gain unauthorized access, identify vulnerabilities, and/or provide recommendations for improvement.
Configuration Review: The system can review the configuration settings of network devices, servers, and applications to ensure they align with security best practices. The review of the configuration settings may be performed by automatically by a service configured to analyze the configuration settings and/or manually by a subject matter expert. Misconfigurations can often lead to security vulnerabilities and should be addressed promptly.
Threat Modeling: The system can use threat modeling techniques to systematically identify potential threats, attack vectors, and security controls relevant to the network environment. The results from the threat modeling can be used to prioritize security efforts and resources based on the most significant risks.
User Access Controls Review: The system can evaluate user access controls and permissions to ensure that only authorized users have access to sensitive data and resources. The system can be configured to periodically (e.g., according to a predefined period) review user privileges and revoke or otherwise adjust unnecessary access rights.
Third-party Assessments: The system can obtain security posture assessments of third-party vendors, suppliers, services, or partners that interact with the network. The system uses the security posture assessments to identify third-party vendors, suppliers, services, or partners that do not satisfy predefined security requirements for the network and/or do not introduce additional risks to the network.
Continuous Monitoring: The system can implement continuous monitoring solutions to detect and respond to security incidents in real-time. The system monitors network traffic, system logs, and behavior patterns for signs of unauthorized access or malicious activities.

Various embodiments provide a decomposable representation of an aggregated security rating (e.g., a numerical score) for the attack surface of a particular network. The aggregated security rating can be decomposed to provide an indication of the security rating contributions by one or more components that contribute to the attack surface.

Various embodiments provide a method, system, and device for identifying network incident risk. The method includes (i) determining a set of incident scores for a set of incidents on a network, (ii) generating a security rating for an attack surface for the network, wherein the security rating is an aggregation of the incident risk scores associated with a subset of risks on the network, and (iii) providing the security rating.

Various embodiments combine asset criticality with exploit intelligence into a single score for easier consumption or prioritization. Further, the single score has a granular prioritization based on representing the incident risk score such as a value between 0 and 1000. The system is dynamic in nature and computes the security rating and incident risk scores to evolve over time as vulnerability statuses change in the wild. In some embodiments, the security rating is normalized for the attack surface size, which enables a better benchmark comparison over varying attack surface sizes. As an example, the security rating is computed based at least in part on expert-driven risk factors that enable the security rating to include critical domain knowledge and asset context into the dynamic weighting of incident scores.

Existing solutions for analyzing the security rating causes users to struggle to prioritize/triage risks. Related art systems do not accurately define or track risk reduction goals or enable the user/system to pinpoint an order in which the attack surface risks are to be addressed to maximize/optimize effectiveness. Specifically, related art systems provide an overwhelming volume of alerts for an attack surface and the related art systems represent the attack surface risks in a manner according to which the business impact of an incident is difficult to discern.

Related art systems overwhelm security operation centers and network administrators with a high volume of alerts. The presentation of these individual alerts requires a significant amount of time for administrators to triage the alerts. In addition, the large number of alerts lead to alert fatigue (e.g., the security operation centers or network administrators treating any single alert as non-critical or unimportant because of the extremely large volume of alerts) Further, representation of these alerts fail to provide any discernible priority or starting point for remediating the alert backlog.

Related art systems represent the attack surface security in a manner in which administrators have difficulty discerning the impact of a particular alert. Additionally, the threat and business context for an alert is not provided to the users.

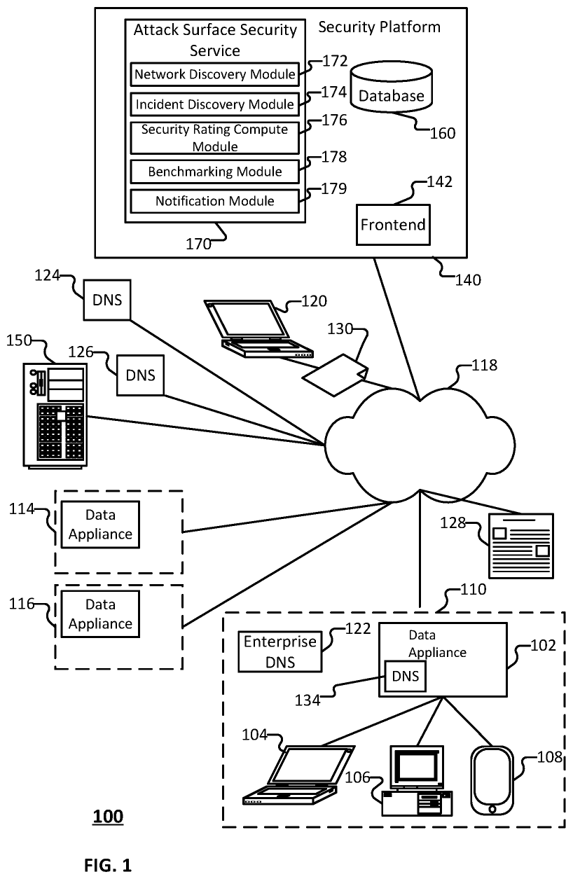

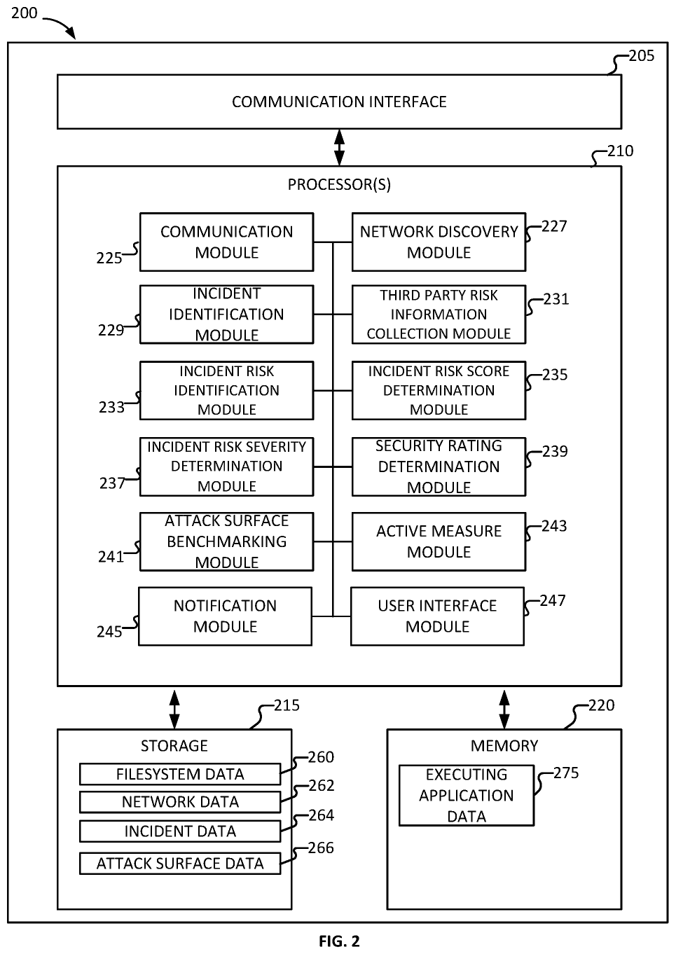

FIG. 1 is a block diagram of an environment for assessing a network attack surface according to various embodiments. In some embodiments, system 100 is implemented by at least part of system 200 of FIG. 2. In some embodiments, at least part of system 100 implements one or more of processes 500-1000.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains or parked domains, or traffic for certain applications (e.g., SaaS applications), or malicious or invalid authentication requests. In some embodiments, data appliance 102 is also configured to enforce policies with respect to traffic that stays within (or from coming into) enterprise network 110.

In some embodiments, data appliance 102 is configured to classify network traffic (e.g., classify as benign, vulnerable, malicious, etc.). Data appliance 102 may classify the network traffic based on the intended domain or other characteristics of the network traffic. For example, data appliance may query a mapping of domains to maliciousness classifications such as a whitelist of benign domains, a blacklist of vulnerable or malicious domains, etc. As another example, data appliance 102 may classify the network traffic based on querying a classifier (e.g., a machine learning model) for the predicted classification. The classifier may be comprised locally at data appliance 102 or remotely such as comprised in security platform 140.

Techniques described herein can be used in conjunction with a variety of platforms (e.g., desktops, mobile devices, gaming platforms, embedded systems, etc.) and/or a variety of types of applications (e.g., Android .apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including one or more of (a) managing/maintaining a security policy configuration(s) for enterprise network 110 and/or devices connected to enterprise network 110 (e.g., managed devices, security entities, etc.), (b) enforcing the security policy configuration or causing a security entity (e.g., a firewall) to enforce the security policy configuration, (c) classifying network traffic, (d) classifying authentication requests and/or connection requests, (e) determining a manner by which authentication requests and/connection requests are to be handled (e.g., based at least in part on a predicted authentication classification, etc.), (f) training a machine learning (ML) model to generate predictions with respect to network traffic classifications, (g) perform networks/attack surface discovery process to identify endpoints and services provided on the network, (h) analyze the network/attack surface to identify vulnerabilities on the attack surface (e.g., vulnerabilities for endpoints or services delivered across the network), (i) determine incident risk scores for the vulnerabilities (e.g., for each incident), (j) determine a security rating based on the incident risk score, (h) configure a user interface to provide security rating information (e.g., to identify the incidents/vulnerabilities, to provide the security rating, to provide benchmarking information, etc.), (i) benchmark a particular network or attack surface against one or more other attack surfaces, etc.

Security platform 140 may implement other services, such as determining an attribution of network traffic to a particular DNS tunneling campaign or tool, indexing features or other DNS-activity information with respect to particular campaigns or tools (or as unknown), classifying network traffic (e.g., identifying application(s) to which particular samples of network traffic corresponding, determining whether traffic is malicious, detecting malicious traffic, detecting C2 traffic, etc.), providing a mapping of signatures to certain traffic (e.g., a type of C2 traffic) or a mapping of signatures to applications/application identifiers (e.g., network traffic signatures to application identifiers), providing a mapping of IP addresses to certain traffic (e.g., traffic to/from a client device for which C2 traffic has been detected, or for which security platform 140 identifies as being benign), performing static and dynamic analysis on malware samples, assessing maliciousness of domains, determining whether domains are parked domains, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain) or benign (e.g., an unparked domain), determining and/or providing an indication or a likelihood that authentication request is malicious, determining and/or providing an indication or a likelihood that network traffic for a particular traffic protocol (e.g., HTTP session data) is malicious, determining a model score, providing/updating a whitelist of input strings, files, domains, source addresses, destination address, authentication requests, or other characteristics or attributes of network traffic deemed to be benign, providing/updating input strings, files, domains, source addresses, destination address, authentication requests, or other characteristics or attributes of network traffic deemed to be malicious, identifying malicious input strings, detecting malicious input strings, detecting malicious files, predicting whether input strings, files, or domains are malicious, and providing an indication that an input string, file, or domain is malicious (or benign).

In some embodiments, attack surface security service 170 can serve as a service for evaluating the security for an attack surface (e.g., a network). Evaluating the security includes discovering the endpoints or services associated with the attack surface, identify vulnerabilities for the attack surface, characterizing the vulnerabilities and assigning (e.g., computing) a corresponding incident risk score, and determining a security rating for the attack surface (e.g., based at least in part on the incident risk scores). Attack surface security service 170 can generate visualizations of the security for the attack surface such as to be provided via a user interface. The visualization may include a geographic representation indicating the incidents/vulnerabilities or indications of other characteristics of the incidents/vulnerabilities.

Although the example shows that security platform 140 comprises dedicated attack surface security service 170, in various other embodiments, attack surface security service 170 may be implemented by another server(s)/service.

In some embodiments, attack security service 170 collects vulnerability data (e.g., CVE data) from third party services such as NVD, etc. Attack security service 170 creates a score for each CVE and combines all the CVE scores on a service, website, or network asset to create a score per service, website or asset (e.g., by invoking a service, website, or network asset score service). Attack security service 170 computes (e.g., by invoking a risk score service) an overall tenant (e.g., attack surface) risk score (e.g., the security rating) based on the CVE scores for the services, websites, or assets invoked by the incident/vulnerability. Attack security service 170 can generate a score per incident for every incident in the tenant.

In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remainder portions of security platform 140 provided by dedicated hardware owned by and under the control of the operator of security platform 140.

In some embodiments, attack surface security service 170 is implemented to determine a security rating for an attack surface. The security rating may be decomposable into a set of risk factors that contribute to the computation of the security rating. For example, the system determines the vulnerabilities associated with the attack surface and determines incident risk scores for the identified vulnerabilities. The system uses the incident risk scores to determine the security rating, such as based on a weighting function that disproportionately assigns weights based on the severity of the vulnerability (e.g., the most severe vulnerabilities are more heavily weighted). In some embodiments, attack surface security service 170 determines the security rating by aggregating the incident risk scores. Attack surface security service 170 can aggregate at least a subset of the incident risk scores such as the incident risk scores for the medium-severity and high-severity vulnerabilities. For example, the low-severity vulnerabilities may be excluded from the computation of the security rating. The security rating thus provides a point of view or assessment of the network from the perspective of an adversary.

In some embodiments, the security rating is determined according to a predefined configuration that specifies the level of granularity or the breadth of the network to be evaluated when determining the security rating. For example, the security rating could be a rating for a global network, a rating for a particular geographic region (e.g., country-level, state-level, city-level, or some other geographic area-level), a rating for a particular business unit, a rating for a particular location, etc. The network breadth to be used for determining the attack surface can be configurable.

In some embodiments, attack surface security service 170 compares a security rating for a particular attack surface to a set of other attack surfaces, such as industry peers of the organization associated with the network surface. The set of other attack surfaces can be configurable. For example, the set of other attack surfaces may be user-defined or otherwise defined by a security policy configured by an administrator.

In some embodiments, attack surface security service 170 (e.g., a security rating or evaluation service) provides an assessment of the security for a network (e.g., a security rating for an attack surface associated with the network). In the example shown, attack surface security service 170 comprises network discovery module 172, incident discovery module 174, security rating compute module 176, benchmarking module 178, and notification module 179. Attack surface security service 170 can receive a request/indication to provide a security rating for an attack surface. The request may specify the particular attack surface to be evaluated. In response to receiving the request, attack surface security service 170 can determine the security rating for the attack surface and provide the security rating. Attack surface security service 170 may further provide recommendations for remediating the identified vulnerabilities of the attack surface.

In some embodiments, attack surface security service 170 dynamically updates the security rating. Attack surface security service 170 can monitor the attack surface to determine a manner in which the attack surface changes over time, such as to identify vulnerabilities that have been resolved/remediated, identify emergent vulnerabilities, to determine the addition or removal of network assets (e.g., devices, services, etc.), to identify how security policies change over time (e.g., new security policies may be implemented, some security policies may be updated or removed, etc.).

Attack surface security service 170 uses network discovery module 172 to perform network discovery. Network discovery module 172 is configured to identify network assets (e.g., endpoints, security entities, etc.) and/or to identify services that are consumed or provided on the network. Network discovery module 172 may receive updated information pertaining to the network posture, such as to identify newly added network assets, removal of certain network assets, etc. For example, network discovery module 172 may periodically (e.g., according to a predefined frequency, which may be configured by an administrator) receive updates from network crawlers or other services that discover network assets or services. Network discovery module 172 may additionally determine security policies being enforced across the network (or at least the attack surface being analyzed).

Attack surface security service 170 uses incident discovery module 174 to perform incident discovery. Incident discovery module 174 can evaluate the network (or at least the attack surface being evaluated) to determine vulnerabilities in the network, such as endpoint vulnerabilities or vulnerabilities in services being provided across the network. As an example, incident discovery module 174 uses the information discovered by network discovery module 172 to determine whether the discovered network assets or services are subject to vulnerabilities. Incident discovery module 174 may be configured to receive information from third party services (e.g., GitHub repositories, Metasploit repositories, etc.), which can be used to evaluate whether the particular network has vulnerabilities. As an illustrative example, a third party may provide an indication of an emergent vulnerability that has been published with respect to a certain version of software, and incident discovery module 174 can receive the indication and evaluate whether any endpoints or other devices on the network run the version of software associated with the vulnerability.

Attack surface security service 170 uses security rating compute module 176 to determine the security rating for a particular network or attack surface. The security rating compute module 176 determines the security rating based at least in part on the identified vulnerabilities. In some embodiments, security rating compute module 176 determines incident scores for the identified vulnerabilities. Security rating compute module 176 aggregates the incident scores (e.g., at least for the high-severity and medium-severity vulnerabilities) to determine the security rating.

Attack surface security service 170 uses benchmarking module 178 to compare a particular network or attack surface to a set of other networks/attack surfaces, such as industry peer networks/attack surfaces, etc.

Attack surface security service 170 uses notification module 179 to provide information pertaining to the network or attack surface security. For example, notification module 179 configures a user interface to be presented to a network administrator or other user. The user interface may comprise an indication of the attack surface/network evaluated, an indication of the security rating for the attack surface, an indication of one or more vulnerabilities associated with the attack surface, a visualization pertaining to the attack surface security (e.g., a geographic map illustrating the security ratings of different regions or the vulnerabilities associated with different regions or locations), etc. In some embodiments, notification module 179 is configured to cause an active measure to be performed to remediate/resolve a vulnerability. For example, notification module 179 can provide to a client system (e.g., an administrator) a recommendation of active measure(s) to be performed. As another example, notification module 179 provides an indication to another system or service to implement the active measure, such as to update a vulnerable software version to a newer and less vulnerable software version, to update a security policy, etc.

FIG. 2 is a block diagram of a system to assess a network attack surface according to various embodiments. In some embodiments, system 200 is implemented by at least part of system 100 of FIG. 1. In some embodiments, at least part of system 200 implements one or more of processes 500-1000.

In some embodiments, system 200 is implemented by a security service, such as a by one or more servers that monitor/evaluate security for an attack surface or network.

System 200 is configured to evaluate an attack surface security and to provide information pertaining to the attack surface security. The evaluation of the attack surface security includes performing network discovery, performing incident or vulnerability discovery, evaluating the incidents or vulnerabilities (e.g., to compute a corresponding incident risk score), and aggregating the evaluation of the incidents/vulnerabilities to determine the security rating.

In the example shown, system 200 implements one or more modules in connection with evaluating an attack surface security, performing active measures to remediate vulnerabilities, determining a security rating for an attack surface, etc. System 200 comprises communication interface 205, one or more processor(s) 210, storage 215, and/or memory 220. One or more processors 210 comprises one or more of communication module 225, network discovery module 227, incident identification module 229, third party risk information collection module 231, incident risk identification module 233, incident risk score determination module 235, incident risk severity determination module 237, security rating determination module 239, attack surface benchmarking module, active measure module 243, notification module 245, and user interface module 247.

In some embodiments, system 200 comprises communication module 225. System 200 uses communication module 225 to communicate with various nodes or end points (e.g., client terminals, firewalls, DNS resolvers, DNS security services, data appliances, other security entities, etc.), third party services, or user systems such as an administrator system. For example, communication module 225 provides to communication interface 205 information that is to be communicated (e.g., to another node, security entity, etc.). As another example, communication interface 205 provides to communication module 225 information received by system 200, such as network traffic originating at a client system and directed to an intended domain (e.g., a domain classified as vulnerable or malicious), third party service information (e.g., indications of emergent vulnerabilities, vulnerability ratings/severities, etc.). Communication module 225 is configured to obtain requests for attack surface security assessments (e.g. a request for the security rating), such as from client devices or other endpoints and to provide a user interface configured with information pertaining to the attack surface. System 200 may use communication module 225 to query third-party service(s), such as services that provide information pertaining to devices, services, vulnerabilities (e.g., newly published vulnerabilities, newly exploited vulnerabilities, etc.). Communication module 225 is further configured to receive one or more settings or configurations from an administrator.

In some embodiments, system 200 comprises network discovery module 227. System 200 uses network discovery module 227 to perform network discovery such as to determine a posture of an attack surface. Network discovery module 227 is configured to identify network assets (e.g., endpoints, security entities, etc.) and/or to identify services that are consumed or provided on the network. Network discovery module 227 may receive updated information pertaining to the network posture, such as to identify newly added network assets, removal of certain network assets, etc. For example, network discovery module 227 may periodically (e.g., according to a predefined frequency, which may be configured by an administrator) receive updates from network crawlers or other services that discover network assets or services. Network discovery module 227 may additionally determine security policies being enforced across the network (or at least the attack surface being analyzed).

In some embodiments, system 200 comprises incident identification module 229. System 200 uses incident identification module 229 to perform incident discovery, such as to identify vulnerabilities associated with the attack surface (e.g., vulnerabilities in endpoints or other devices on the network, vulnerabilities in services provided across the network, etc.). Incident identification module 229 can evaluate the network (or at least the attack surface to being evaluated) to determine vulnerabilities in the network, such as endpoint vulnerabilities or vulnerabilities in services being provided across the network. As an example, incident identification module 229 uses the information discovered by network discovery module 227 to determine whether the discovered network assets or services are subject to vulnerabilities. Incident identification module 229 may be configured to receive information from third party services, which can be used to evaluate whether the particular network has vulnerabilities. As an illustrative example, a third party may provide an indication of an emergent vulnerability that has been published with respect to a certain version of software, and incident identification module 229 can receive the indication and evaluate whether any endpoints or other devices on the network run the version of software associated with the vulnerability.

In some embodiments, system 200 comprises third party risk information collection module 231. System 200 uses third party risk information collection module 231 to obtain third party risk information from third party services. For example, third party risk information collection module 231 obtains information pertaining to one or more of emergent vulnerabilities (e.g., newly discovered/published vulnerabilities), exploitation of certain vulnerabilities, a vulnerability maturity, whether the vulnerability was exploited within a certain time period(s), etc. Additionally, third party risk information collection module 231 may obtain security scores for vulnerabilities, such as Common Vulnerability Scoring System (CVSS) score, an Exploit Prediction Scoring System (EPSS) score, etc.

In some embodiments, system 200 comprises incident risk identification module 233. System 200 uses incident risk identification module 233 to identify the risk information for the various incidents (e.g., vulnerabilities) associated with the attack surface. For example, incident risk identification module 233 determines a set of risk factors invoked by a particular vulnerability. Examples of risk factors that can be used to characterize an incident include an indication that a device or service is a critical system, a version of a device or software running on the device, a misconfiguration, a product know to have an unintentional vulnerability, a product or device that exposes the network to devices/services outside the network, a product or device commonly deemed to be risky, a lack of robust cryptography, etc. However, various other risk factors may be implemented. In some embodiments, the risk factors are defined by domain experts, community feedback, or third party services. Incident risk identification module 233 applies one or more risk factors to each incident type.

In some embodiments, system 200 comprises incident risk score determination module 235. System 200 uses incident risk score determination module 235 to determine a measure of the severity associated with the set of incidents. As an example, incident risk score determination module 235 determines an incident risk score for each incident in the set of incidents. Incident risk score determination module 235 determines the incident risk score for a particular incident based at least in part on (a) a set of one or more alert scores, and (b) a vulnerability score. For example, the incident risk score is determined based at least in part on (i) a sum of the alert scores for various risk factors associated with the vulnerability, and (ii) the vulnerability score associated with the incident. In some embodiments, the incident risk score is determined according to Equation 1.

In some embodiments, incident risk score determination module 235 determines an incident risk score based on querying a machine learning model trained to assign incident risk scores to incidents. In other implementations, incident risk score determination module 235 implements an artificial intelligence process to automatically assign the corresponding incident risk score.

In some embodiments, the one or more alert scores for a particular incident are determined based at least in part on a set of risk factors associated with the alert scores. For example, each incident can comprise a plurality of associated risk factors. The set of risk factors can be predefined risks that are defined by domain experts. Each risk factor has an associated risk score impact value. The risk score impact value(s) can be set by the domain experts that specified the risk factor(s). The risk score impact value can be a value between 0 and 70 or another predefined range.

In some embodiments, the alert score for a particular risk factor can be determined based at least in part on the risk score impact value for the risk factor and an alert criticality for the risk factor. The alert score for a risk may be dynamic and updated based on the evolving risk, such as when network configurations are updated, policies are implemented, etc. An alert criticality score can be defined based on the classification of the risk factor. The alert criticality can be set based on the perceived severity (e.g., by a set of domain experts), such as based on a classification of low severity, medium severity, or high severity. The system may store a mapping of alert severities to corresponding alert criticality scores. To compute the alert score, the system can query the mapping of alert severities to corresponding alert critical scores to determine the alert criticality score/contribution to the alert score for the particular risk factor. As an example, the alert criticality for a low-severity risk is set to 0; the alert criticality for a medium-severity risk is set to 10; and the alert criticality for a high-severity risk is set to 20. Various other values may be used as the alert criticality for risks.

The alert score may be a sum of: (i) the sum of all the risk score impact values for risk factors associated with the incident, and (ii) the alert criticality for the incident.

In some embodiments, the vulnerability score is determined based at least in part on one or more of (a) a CVSS score, (b) an EPSS score, and (c) exploit intelligence score.

The exploit intelligence score is determined based at least in part on exploit information associated with the particular incident. Examples of the exploit information include (i) an indication that the exploit is implemented in the wild, (ii) an exploit maturity (e.g., has the exploit been weaponized, discovered, published, etc.), (iii) an indication that the exploit has been exploited within a first predefined period of time (e.g., within the last month), (iv) an indication that the exploit has been exploited within a second predefined period of time (e.g., within the last two years), etc. Various other types of information for the exploit may be collected and used in connection with determining the vulnerability score. The exploit intelligence score may be determined according to a predefined exploit intelligence function. As an example, the predefined exploit intelligence function determines an aggregate score of the types of exploit information (e.g., a sum of the scores for the various exploit information collected). As another example, the predefined exploit intelligence function determines an average score among the types of exploit information.

In some embodiments, the exploit intelligence score is the sum of exploit intelligence score impact values for the exploit intelligence factors associated with the particular incident. Examples of exploit intelligence factors include the vulnerability being exploited in the wild, the vulnerability maturity (e.g., the vulnerability has been weaponized), the vulnerability has been exploited in a first predefined time period (e.g., a past week or past month), and the vulnerability has been exploited in a second predefined time period (e.g., past year or past two years), etc. Each exploit intelligence factor has an associated exploit intelligence score impact values, which is a value between a predefined exploit intelligence score range such as between 0 and 50. Various other exploit intelligence factors may be implemented. System 200 may obtain the exploit intelligence factors from third party services such as services that monitor known and emerging exploits.

The vulnerability score is determined according to a predefined function. As an example, the predefined function determines a sum of two or more of (a) the CVSS score, (b) the EPSS score, and (c) the exploit intelligence score. As another example, the predefined function determines an average score among (a) the CVSS score, (b) the EPSS score, and (c) the exploit intelligence score.

In response to determining the alert scores for the risk factors associated with the incident and the vulnerability score associated with the incident, incident risk score determination module 235 determines the incident risk score. In some embodiments, the incident risk score is computed according to Equation 1 below.

$$Incident Risk Score = ( \sum Alert Score ) + Vulnerability Score \qquad ( 1 )$$

In some embodiments, the maximum incident risk score is 1000.

In some embodiments, system 200 comprises incident risk severity determination module 237. System 200 uses incident risk severity determination module 237 to determine the severity of a particular incident. The incident risk severity determination module 237 can determine the severity of particular incident based on the incident risk score for such incident. Additionally, incident risk severity determination module 237 can use the incident risk scores for the other incidents of the attack surface in connection with determining the severity for a particular incident (e.g., the system can assign severities based on the relative incident risk scores for the incidents associated with the attack surface).

In some embodiments, incident risk severity determination module 237 classifies the incident as a particular severity based at least in part on determining an incident risk score range within the incident risk score for a particular incident. As an example, incidents having an incident risk score greater than 750 may be deemed high-severity; incidents having an incident risk score greater than 500 and less than 750 may be deemed medium-severity; and incidents having an incident risk score less than 500 may be deemed low-severity. The foregoing range thresholds are merely illustrative and various embodiments may implement different mappings of incident score ranges to severities.

Alternatively, in some embodiments, in incident risk severity determination module 237 classifies the incident as a particular severity based on the relative incident risk score of the particular incident and the incident risk scores of other incidents associated with the attack surface. As an illustrative example, system 200 may classify the 25% of incidents having highest incident risk scores as high-severity; system 200 may classify the incidents having incident risk scores in the second and third quartiles as medium severity; and system 200 may classify the 25% of incidents having lowest incident risk scores as low-severity.

In some embodiments, system 200 comprises security rating determination module 239. System 200 uses security rating determination module 239 to determine the security rating for an attack surface. Security rating determination module 239 determines the security rating for the attack surface based at least in part on incident risk scores for incidents associated with the attack surface.

In some implementations, system 200 uses the incident risk scores for all incidents associated with the attack surface to compute the security rating.

In other implementations, system 200 uses the incident risk scores for all high-severity incidents and medium-severity incidents to compute the security rating. For example, system 200 excludes the low-severity incidents from the computation of the security rating (e.g., the low-severity incidents do not contribute to the security rating value).

As an illustrative example, an attack surface for a tenant has K incidents: [I₀, I₁, I₂, . . . I_{K-1}]. Each incident Iₜ is mapped to an evenly spaced coordinate in the domain [0.0, 1.0) based on its 0-indexed rank i using Equation 2.

$$P ( i ) = \frac{i}{K} \qquad ( 2 )$$

In some embodiments, security rating determination module 239 determines the security ratings based on assigning weights to the incidents contributing to the computation of the security rating (e.g., all incidents for the attack surface, all medium and high-severity incidents for the attack surface, or some other defined subset of incidents, etc.).

Various weighting functions may be implemented to prioritize the set of incidents. The system assigns weightings for the set of incidents so that the security rating is sensitive to the most serious/severe incidents. In some embodiments, the weighting function is selected to distribute at least ninety percent (90%) of the collective weightings to the top fifty percent (50%) of most severe incidents (e.g., the half of the set of incidents having a highest incident risk score). Based on the weighting according to the weight function (e.g., the weighting function of Equation 3), a serious incident has a disproportionately large impact on the security rating. For example, if an attack network has a single extremely severe incident and a set of relatively low severity incidents, the security rating is computed/configured to reflect the extremely severe incident.

In some embodiments, security rating determination module 239 uses the weighting function defined in Equation 3 to compute the weights for the incidents contributing to the security rating computation. The weighting function of Equation 3 disproportionately weighs the most severe incidents and thus the more severe an incident the greater its contribution to the computation of the security rating. The most severe incidents are most heavily weighted for computing the security rating. System 200 weights the incidents to ensure that the security rating is most sensitive to the most serious vulnerabilities.

$$W ( x ) = 1 - tanh ( \frac{5 x}{2} ) \qquad ( 3 )$$

In response to determining the weightings for the incidents contributing to the security rating computation, security rating determination module 239 determines the security rating. The determining the security rating may include computing an attack surface risk S̅ in accordance with Equation 4.

$$\overline{S} = \frac{{\sum }_{i = 0}^{K - 1} W ( P ( i ) ) {I}_{i}}{{\sum }_{i = 0}^{K - 1} W ( Pi )} \qquad ( 4 )$$

Security rating determination module 239 determines the security rating S based at least in part on the attack surface risk S̅. For example, security rating determination module 239 determines the security rating based at least in part on inverting and scaling the attack surface risk S̅. Security rating determination module 239 may invert and scale the attack surface risk S̅ according to Equation 5.

$$S = 100 * ( 1.0 - \overline{S} ) \qquad ( 5 )$$

In some embodiments, the security rating is normalized according to a normalization factor that is related to the size of the tenant/attack surface.

In some embodiments, the security rating is dynamically computed. For example, any new vulnerabilities/issues serves to increase the security rating. As another example, any resolutions to existing vulnerabilities/issues should serve to decrease the security rating. Thus, as emerging vulnerabilities are identified or existing vulnerabilities are remediated, system 200 recomputes/updates the security rating for the attack surface. System 200 converts up-to-date network scans into an aggregate grade (e.g., the security rating) that is sensitive to changes in the threat landscape of the attack surface.

In some embodiments, system 200 comprises attack surface benchmarking module 241. System 200 uses attack surface benchmarking module 241 to illustrate a comparison between a particular attack surface and a set of other attack surfaces used to serve as a benchmark. The security ratings for attack surfaces may be normalized for the attack surface size, which can enable a benchmark comparison over varying attack surface sizes. In some embodiments, the set of other attack surfaces to be used as a benchmark for a particular incident are defined according to a benchmark policy or according to user input. As an example, the set of other attack surfaces correspond to peer attack surfaces associated with the same industry type as the particular attack surface. As an example, the set of other attack surfaces correspond to attack surfaces within a same geographic region as the particular attack surface being analyzed.

In some embodiments, system 200 comprises active measure module 243. System 200 uses active measure module 243 to cause an active measure to be performed with respect to an identified risk(s)/vulnerability associated with the particular attack surface. System 200 may implement the active measure or provide an instruction/indication to another system or service to implement the active measure.

In some embodiments, active measure module 243 determines at least one incident for which an active measure is to be performed such as to remediate or otherwise resolve the incident. Active measure module 243 can determine the incidents for which an active measure is to be performed based on a top N most severe incidents, a determination of incidents having incident scores greater than a predefined incident score threshold, etc.

As an example, system 200 may perform active measures (or cause active measures to be performed) with respect to a top N most severe incidents, where N is a positive integer. System 200 may identify the top N most severe incidents and determine active measures to resolve the N most severe incidents.

As another example, system 200 performs active measures with respect to the incidents (e.g., incidents associated with the network/attack surface) having an incident score greater than the predefined incident score threshold. The predefined incident score threshold may be configured by an administrator, such as to target those most severe incidents.

In some embodiments, the active measure to be performed with respect to a particular incident is determined based at least in part on one or more of (i) the incident type, (ii) an incident severity, (iii) a risk factor associated with the incident, and (iv) a particular node from which the incident arises or is vulnerable to the incident (e.g., a node having a particular geographic location, a node that is unmanaged by a network administrator, etc.). The active measure may be determined based on querying mapping of one or more characteristics associated with the incident to active measures, such as a mapping of incident types to active measures or a mapping of incident severities and active measures.

In some embodiments, system 200 comprises notification module 245. System 200 uses notification module 245 to provide security information pertaining to the attack surface. As an example, notification module 245 provides an indication/alert to another system or user of newly identified vulnerabilities or an indication that a particular vulnerability has been remediated (e.g., improved or resolved). As another example, notification module 245 provides benchmarking information to another system or user, such as an indication of a benchmark of a particular attack surface against a set of other attack surfaces. As another example, notification module 245 provides an indication of a security rating for an attack surface. Notification module 245 may generate an alert in response to determining that the security rating for the attack surface has increased beyond a predefined security rating threshold.

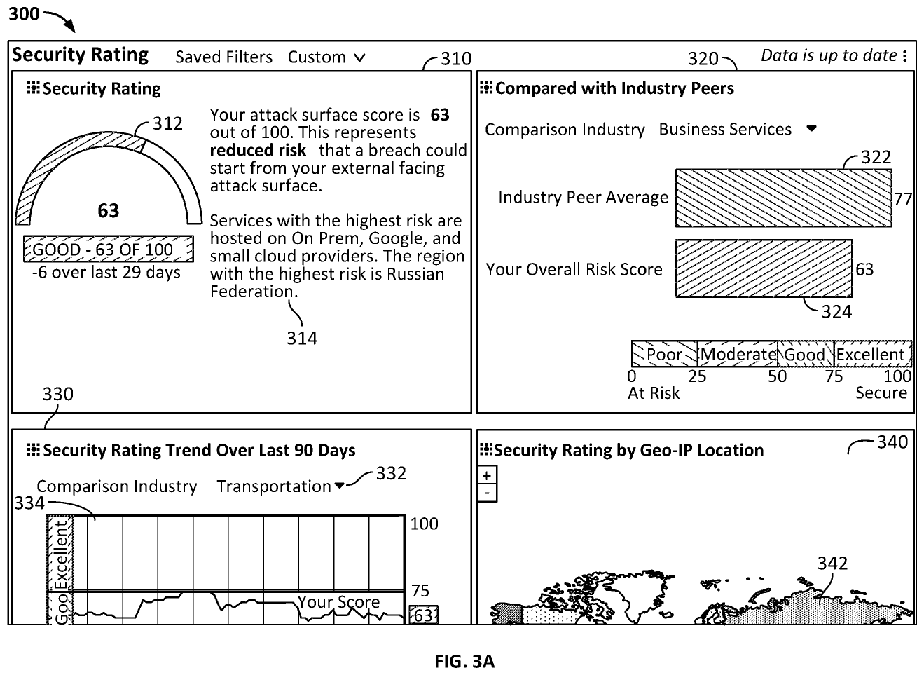

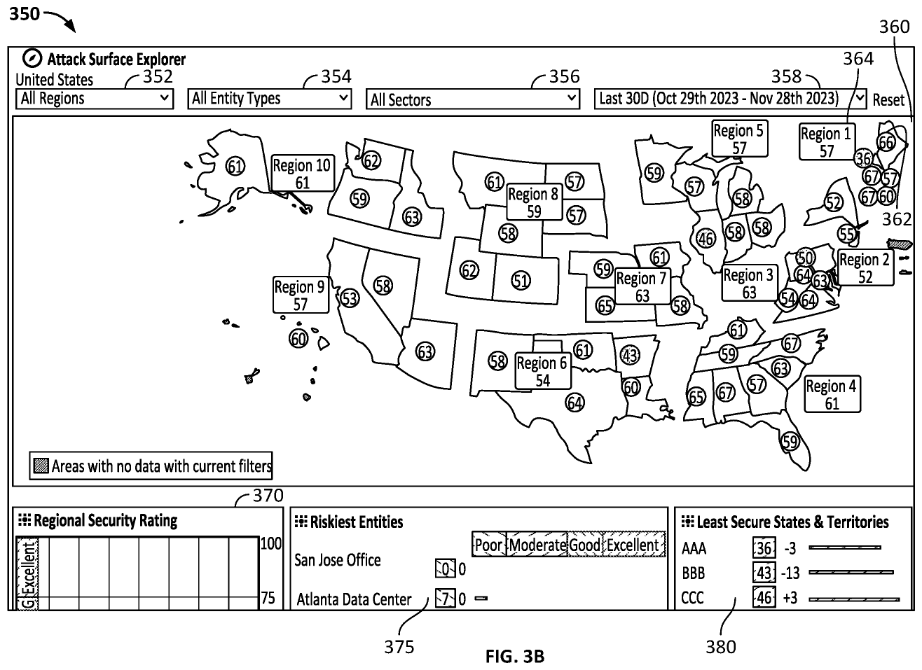

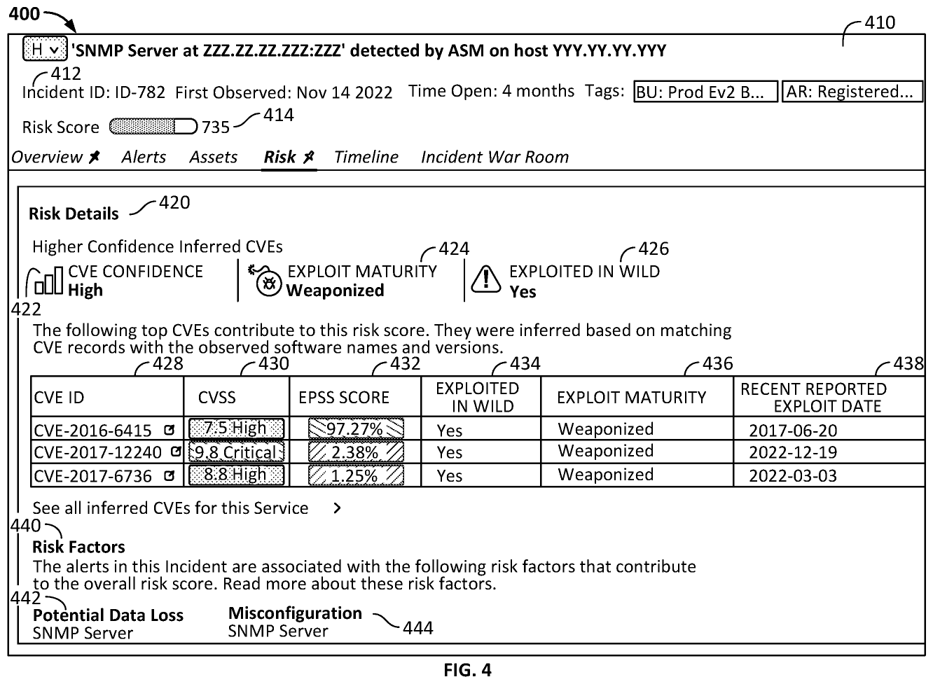

In some embodiments, system 200 comprises user interface module 247. System 200 uses user interface module 247 to configure and provide a user interface to a user, such as to a client system used by an administrator. User interface module 247 configures a user interface to provide the notifications or alerts, such as alerting the user of new vulnerabilities or improvements or deteriorations in the security rating for a particular attack surface. As an example, user interface module 247 configures a user interface to display security information for an attack surface, such as user interface 300 of FIG. 3A, user interface 350 of FIG. 3B, and/or user interface 400 of FIG. 4. In some embodiments, the user interface 350 comprises elements that enables a user to drill down into the contributions to the security rating, such as to isolate the contributions made by a set of one or more selected incidents.

According to various embodiments, storage 215 comprises one or more of filesystem data 260, network data 262, incident data 265, and attack surface data 266. Storage 215 comprises a shared storage (e.g., a network storage system) and/or database data, and/or user activity data.

In some embodiments, filesystem data 260 comprises a database such as one or more datasets (e.g., datasets comprising samples of connection requests, mappings of domains to redirect addresses). Filesystem data 260 comprises data such as historical information pertaining to HTTP request data or network traffic, a whitelist of network traffic profiles (e.g., hashes or signatures for the HTTP request data) or IP addresses deemed to be safe (e.g., not suspicious, benign, etc.), a blacklist of network traffic (e.g., authentication request) profiles deemed to be suspicious or malicious, a dataset of known vulnerabilities (e.g., information obtained from third party services that monitor new and existing vulnerabilities), etc.

In some embodiments, network data 262 comprises information obtained based on performing a network discovery. For example, network data 262 provides a posture of an attack surface, such an indication of network assets associated with the attack surface (e.g., client systems, managed devices, security entities, IoT devices, etc.) or an indication of services associated with the attack surface (e.g., services received and consumed by assets on the attack surface or services provided by the attack surface such as services exposed to devices outside the network).

In some embodiments, incident data 264 comprises information pertaining to one or more incidents associated with an attack surface. For example, incident data 264 stores information obtained by performing incident discovery. Incident data 265 may comprise incident risk scores, alert scores, vulnerability scores, or information used to compute those scores.

In some embodiments, attack surface data 266 comprises security information for an attack surface, such as information pertaining to a security rating or a benchmarking of the attack surface to a set of other attack surfaces.

According to various embodiments, memory 220 comprises executing application data 275. Executing application data 275 comprises data obtained or used in connection with executing an application such as an application executing a hashing function, an application to extract information from connection requests, authentication requests, webpage content, an input string, an application to extract information from a file, or other sample, etc. In embodiments, the application comprises one or more applications that perform one or more of receive and/or execute a query or task, generate a report and/or configure information that is responsive to an executed query or task, and/or provide to a user information that is responsive to a query or task. Other applications comprise any other appropriate applications (e.g., an index maintenance application, a communications application, a machine learning model application, an application for detecting suspicious authentication requests, an application for detecting malicious network traffic or malicious/non-compliant applications such as with respect to a corporate security policy, a document preparation application, a report preparation application, a user interface application, a data analysis application, an anomaly detection application, a user authentication application, a security policy management/update application, etc.).

FIG. 3A is an illustration of user interface configured to visualize information pertaining to a security rating for a particular attack surface according to various embodiments. In the example shown, user interface 300 comprises various security information pertaining to an attack surface.

In some embodiments, user interface 300 is configured to display security rating information 310. As illustrated, the security rating information 310 comprises an indication of the current security rating for the particular attack surface. Security rating information 310 may comprise security rating visualization 312 which visualizes the severity of the security rating. For example, security rating visualization 313 provides two segments that form a gauge, and a first segment is shaded based on the security rating value. Security rating information 310 may comprise security rating summary information 314, which is obtained by analyzing the security rating for the security rating for the attack surface. The security rating summary information 314 may provide an analysis of whether the security rating is good/bad. The security rating summary information 314 may comprise an indication of the highest risk vulnerabilities associated with the attack surface, such as particular services consumed or provided by the attack surface or geographic regions comprising network assets.

In some embodiments, user interface 300 is configured to display security rating benchmark information 320. As illustrated, the security rating benchmark information 320 comprises information obtained by benchmarking a particular attack surface against a set of one or more other attack surfaces. User interface 300 may comprise a selectable element that enables a user to select the set of other attack surfaces to be used to benchmark the particular attack surface (e.g., geographic regions, industry type, business units, etc.). As illustrated, benchmark information 320 may comprise an indication of a security rating for the set of other attack surfaces 322, such as an average security rating across the set of other attack surfaces. Benchmark information 320 may further comprise an indication of the security rating for the particular attack surface 324. The indication of a security rating for the set of other attack surfaces 322 and the indication the security rating for the particular attack surface 324 may be juxtaposed to enable an easy comparison or determination of a relative security rating for the particular attack surface.

In some embodiments, user interface 300 is configured to display security trend information 330. The security trend information 330 may comprise a chart 334 that illustrates how the security rating has changed over a predefined time period (e.g., a time period selected by the user). In the example shown, the predefined time period is the preceding ninety days. The security trend information 330 may comprise a selectable element 332 that enables a user to select a set of other attack surfaces to illustrate on the chart 334 for a quick comparison of the security rating trend for the particular attack surface against a benchmark of attack surfaces.

In some embodiments, user interface 300 is configured to display security rating geographic information 340. Security rating geographic information 340 may provide an indication(s) of the security rating for particular geographic regions of the attack surface or the contributions by various geographic regions to the overall attack surface security rating. In the example shown, security rating geographic information 340 comprises visualization 342 that comprises a map of a predefined geographic area (e.g., the world, a continent, or a particular country) with shadings (e.g., colorings) for the severity of the security ratings based on the geographic location.

FIG. 3B is an illustration of user interface configured to visualize information pertaining to a security rating for a particular attack surface according to various embodiments. In the example shown, user interface 350 is a configurable user interface that enables a user to explore the security for the attack surface. For example, user interface 350 comprises a set of configurable elements 352, 354, 356, and 358 that the user can use to define the parameters for the attack surface for which a security rating is to be computed/analyzed. Element 352 (e.g., a drop down menu) allows a user to select the regions for which the security rating(s) are to be visualized. Element 354 (e.g., a drop down menu) allows a user to select the entity types to be visualized or used to compute the security ratings. The entity types may include device types, service types, etc. Element 356 (e.g., a drop down menu) allows a user to select sectors of the attack surface to be visualized. Element 358 enables a user to define a time period over which the security rating is to be computed or for which the visualization is to be generated.

In response to the user (or other system or service) defining the parameters for the attack surface, the system generates visualization 360 that represents the attack surface according to the parameters. Visualization 360 may visualize the attack surface by geography and annotate the geographic area with security information for the various geographic regions, such as region 365 (e.g., New England). Each geographic region may comprise more granular security information associated with contributions from that region, such as an indication of a number of vulnerabilities or vulnerable assets within the region. In the example shown, region 365 is annotated to include an indication 362 of a security rating for a particular geographic location (e.g., a state).

In some embodiments, user interface 350 further comprises security rating summary information, such as a security rating information 370, a riskiest entities/assets information 375 and/or least secure geographic regions 380. In the example shown, the security rating information 370 comprises a chart illustrating the security rating trends (e.g., over the predefined time period according to the configured parameters of user interface 350). In the example shown, a riskiest entities/assets information 375 comprises an indication of the entities that pose the greatest risk to the attack surface. In the example shown, least secure geographic regions 380 provides an indication of the geographic regions (e.g., states) that are least secure or that have a lowest security rating.

FIG. 4 is an illustration of user interface configured to visualize information pertaining to an incident identified for a particular attack surface according to various embodiments. According to various embodiments, the system configures a user interface(s) to enable a user or other system/service to drill down to analyze particular incidents, such as to determine the contribution of a particular incident to the overall security rating for the attack surface. In the example shown, user interface 400 enables a user to decompose the security rating to contributions by particular incidents.

User interface 400 is configured to comprise incident summary information 410. Incident summary information 410 provides security information such as the incident risk score 414 for a particular incident, which is identified by incident identifier 412.

User interface 400 is configured to provide incident detailed information 420. In the example shown, incident detailed information 420 comprises detailed information of various risk factors or information used to configure the vulnerability score for the particular incident. For example, incident detailed information 420 comprises a CVE confidence score 422, an exploit maturity indication 424, an exploit usage indication 426 (e.g., an indication that the vulnerability is exploited in the wild, etc.).

The incident detailed information 420 may comprise information pertaining to a set of CVEs that contribute to the incident risk score for the incident. For example, the incident detailed information 420 comprises a chart that lists the CVEs and provides incident risk score contributions. The chart includes a CVE identifier field 428, a CVSS score field 430, an EPSS score field 432, an exploit in the wild indicator 434, an exploit maturity indicator 436, and an exploitation date field 438.

Incident detailed information 420 may further comprise risk factor analysis information 440. The risk factor analysis information 440 may allow the user to obtain information about the risk factors (e.g., a description of the particular risk factor flagged).

Incident detailed information may further comprise a vulnerability exposure indication 442 such as an indication of a particular entity from which data loss is possible/likely.

Incident detailed information may further comprise a misconfiguration exposure indication 444 such as an indication of a particular entity that is deemed to be misconfigured.

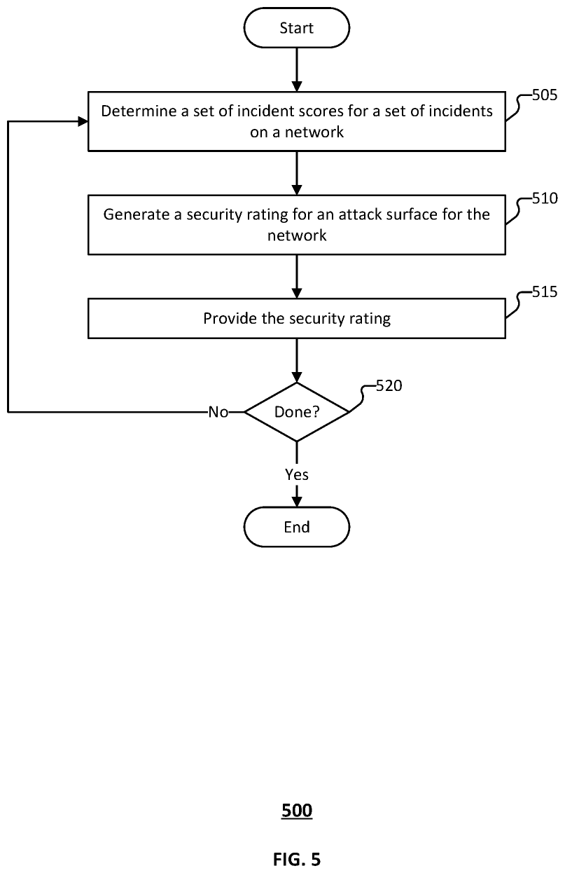

FIG. 5 is a flow diagram of a method for identifying network incident risk according to various embodiments. In various embodiments, process 500 is implemented at least in part by system 100 of FIG. 1 and/or system 200 of FIG. 2.

In some implementations, process 500 may be implemented by one or more servers, such as in connection with providing a service to a network (e.g., a security entity and/or a network endpoint such as a client device). In some implementations, process 500 may be implemented by a security service that analyzes the security posture of a network such as attack surface vulnerabilities, or provides an assessment of the attack surface such as based on computing a security rating for an attack surface and/or configuring and providing a user interface that provides the security rating or a visualization of the security rating or attack surface.

At 505, the system determines a set of incident scores for a set of incidents on a network. At 510, the system generates a security rating for an attack surface for the network. At 515, the system provides the security rating. At 520, a determination is made as to whether process 500 is complete. In some embodiments, process 500 is determined to be complete in response to a determination that no further security ratings are to be determined/provided, no further attack surfaces are to be evaluated, a particular attack surface has no further medium or high severity risks, an administrator indicates that process 500 is to be paused or stopped, etc. In response to a determination that process 500 is complete, process 500 ends. In response to a determination that process 500 is not complete, process 500 returns to 505.

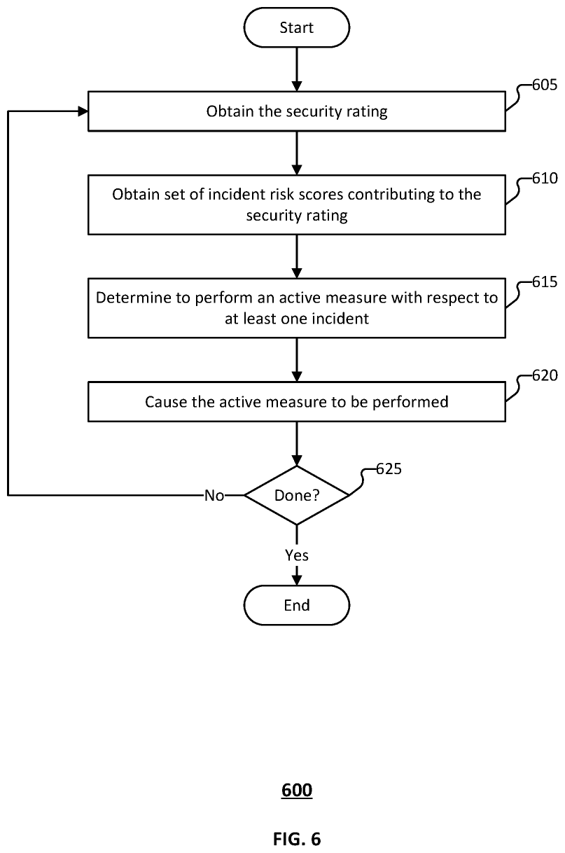

FIG. 6 is a flow diagram of a method for remediating an incident risk identified for a particular attack surface according to various embodiments. In various embodiments, process 600 is implemented at least in part by system 100 of FIG. 1 and/or system 200 of FIG. 2.

In some implementations, process 600 may be implemented by one or more servers, such as in connection with providing a service to a network (e.g., a security entity and/or a network endpoint such as a client device). In some implementations, process 600 may be implemented by a security service that analyzes the security posture of a network such as attack surface vulnerabilities, or provides an assessment of the attack surface such as based on computing a security rating for an attack surface and/or configuring and providing a user interface that provides the security rating or a visualization of the security rating or attack surface.

At 605, the system obtains the security rating.

At 610, the system obtains a set of incident risk scores contributing to the security rating. According to various embodiments, the security rating is decomposable to the various incidents (e.g., with corresponding incident risk scores). For example, the security rating is determined based on contributions from respective incident scores for a set of incidents associated with a network.

At 615, the system determines to perform an active measure with respect to at least one incident. In some embodiments, the system determines at least one incident for which an active measure is to be performed such as to remediate or otherwise resolve the incident. The system can determine the incidents for which an active measure is to be performed based on a top N most severe incidents, a determination of incidents having incident scores greater than a predefined incident score threshold, etc.

As an example, the system may perform active measures with respect to the top N most severe incidents, where N is a positive integer. The system may identify the top N most severe incidents and determine active measures to resolve the N most severe incidents.

As another example, the system performs active measures with respect to the incidents (e.g., incidents associated with the network/attack surface) having an incident score greater than the predefined incident score threshold. The predefined incident score threshold may be configured by an administrator, such as to target those most severe incidents.

In some embodiments, the active measure to be performed with respect to a particular incident is determined based at least in part on one or more of (i) the incident type, (ii) an incident severity, (iii) a risk factor associated with the incident, and (iv) a particular node from which the incident arises or is vulnerable to the incident (e.g., a node having a particular geographic location, a node that is unmanaged by a network administrator, etc.). The active measure may be determined based on querying mapping of one or more characteristics associated with the incident to active measures, such as a mapping of incident types to active measures or a mapping of incident severities and active measures.

At 620, the system causes the active measure to be performed. The system may perform the active measure or cause (e.g., provide an indication to) another system or service to perform the active measure.

At 625, a determination is made as to whether process 600 is complete. In some embodiments, process 600 is determined to be complete in response to a determination that no further security ratings are to be determined/provided, no further attack surfaces are to be evaluated, no further active measures are to be performed, a particular attack surface has no further medium or high severity risks, an administrator indicates that process 600 is to be paused or stopped, etc. In response to a determination that process 600 is complete, process 600 ends. In response to a determination that process 600 is not complete, process 600 returns to 605.

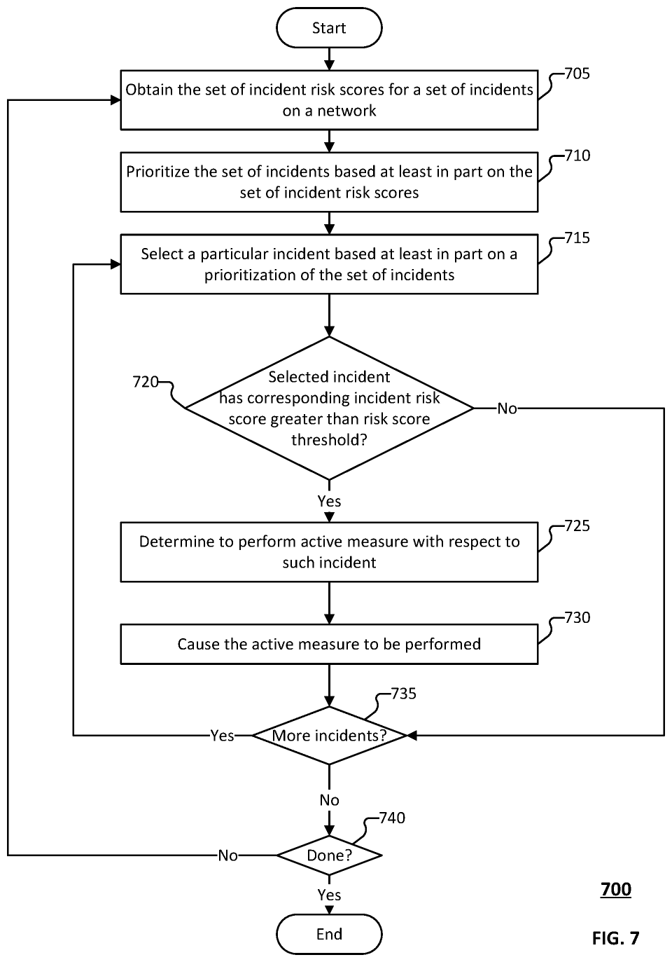

FIG. 7 is a flow diagram of a method for remediating an incident risk identified for a particular attack surface according to various embodiments. In various embodiments, process 700 is implemented at least in part by system 100 of FIG. 1 and/or system 200 of FIG. 2.

In some implementations, process 700 may be implemented by one or more servers, such as in connection with providing a service to a network (e.g., a security entity and/or a network endpoint such as a client device). In some implementations, process 700 may be implemented by a security service that analyzes the security posture of a network such as attack surface vulnerabilities, or provides an assessment of the attack surface such as based on computing a security rating for an attack surface and/or configuring and providing a user interface that provides the security rating or a visualization of the security rating or attack surface.

In some embodiments, process 700 is invoked by a system or service in order to identify the incidents or vulnerabilities associated with an attack surface to be remediated/resolved. The system can decompose the security rating to determine the incidents that contributed to computation of the security rating (e.g., the incidents having incident risk scores that exceed a particular threshold used to determine whether to count the incident in computing the security rating). In response to identifying the incidents contributing to the security rating, the system can then further determine a subset of those incidents to be remediated/resolved.

At 705, the system obtains the set of incident risk scores for a set of incidents on a network. In some embodiments, the obtaining the set of incident risk scores comprises performing a discovery of the network (e.g., to identify devices or other entities or characteristics associated with the network), evaluating the network to identify a set of vulnerabilities of the attack surface for the network, and evaluating the set of vulnerabilities to assess the risks for the vulnerabilities.

After identifying the set of vulnerabilities for the attack surface, incident risk scores are computed for each vulnerability. In some embodiments, the incident risk score for a particular incident (e.g., the vulnerability) is based on a set of one or more alert scores associated with the incident and a vulnerability score associated with the incident. For example, the incident risk score is determined based at least in part on (i) a sum of the alert scores for various risk factors associated with the vulnerability, and (ii) the vulnerability score associated with the incident.

In some embodiments, the set of one or more alert scores for a particular incident are respectively associated with a set of risk factors for the incident. For example, each incident can comprise a plurality of associated risk factors. The risk factors may be defined or configured by one or more domain experts. The system can apply a set of risk factors for each risk or alert fact. Risk score impact values can be set for the set of risk factors. An alert score for a particular risk factor can be determined based at least in part on the risk score impact value for the risk factor and an alert criticality for the risk factor. The alert score for a risk may be dynamic and updated based on the evolving risk, such as when network configurations are updated, policies are implemented, etc. An alert criticality score can be defined based on the classification of the risk factor. The alert criticality can be set based on the perceived severity (e.g., by a set of domain experts), such as based on a classification of low severity, medium severity, or high severity. The system may store a mapping of alert severities to corresponding alert criticality scores. To compute the alert score, the system can query the mapping of alert severities to corresponding alert critical scores to determine the alert criticality score/contribution to the alert score for the particular risk factor.

At 710, the system prioritizes the set of incidents based at least in part on the set of incident risk scores. In some embodiments, the system prioritizes at least a subset of the set of incidents based at least in part on assigning weights to at least a subset of the incidents. The weighting function used in connection with assigning weights to at least a subset of the incidents disproportionately assigns higher weightings based on the severity of the incident (e.g., based at least in part on the corresponding incident risk score).

At 715, the system selects a particular incident based at least in part on a prioritization of the set of incidents.

At 720, the system determines whether the selected incident has a corresponding incident risk score greater than a risk score threshold. The risk score threshold may be predefined. An administrator may configure the risk score threshold to adjust the sensitivity of the security rating.

In response to determining that the system determines that the selected incident has a corresponding incident risk score greater than the risk score threshold at 720, process 700 proceeds to 735. Conversely, in response to determining that the system determines that the selected incident has a corresponding incident risk score greater than the risk score threshold at 720, process 700 proceeds to 725 at which the system determines to perform an active measure with respect to such incident (e.g., the selected incident).

At 730, the system causes the active measure to be performed. The system causes an active measure to be performed for those incidents having a corresponding incident risk score exceeding the risk score threshold. For example, the system identifies the most severe incidents and causes the active measure in order to remediate or otherwise resolve the incident.

At 735, the system determines whether more incidents are to be analyzed. In response to determining that more incidents are to be analyzed at 735, process 700 returns to 715 and process 700 iterates over 715-735 until no further incidents are to be analyzed.

At 740, a determination is made as to whether process 700 is complete. In some embodiments, process 700 is determined to be complete in response to a determination that no further security ratings are to be determined/provided, no further attack surfaces are to be evaluated, no further active measures are to be performed, a particular attack surface has no further medium or high severity risks, an administrator indicates that process 700 is to be paused or stopped, etc. In response to a determination that process 700 is complete, process 700 ends. In response to a determination that process 700 is not complete, process 700 returns to 705.

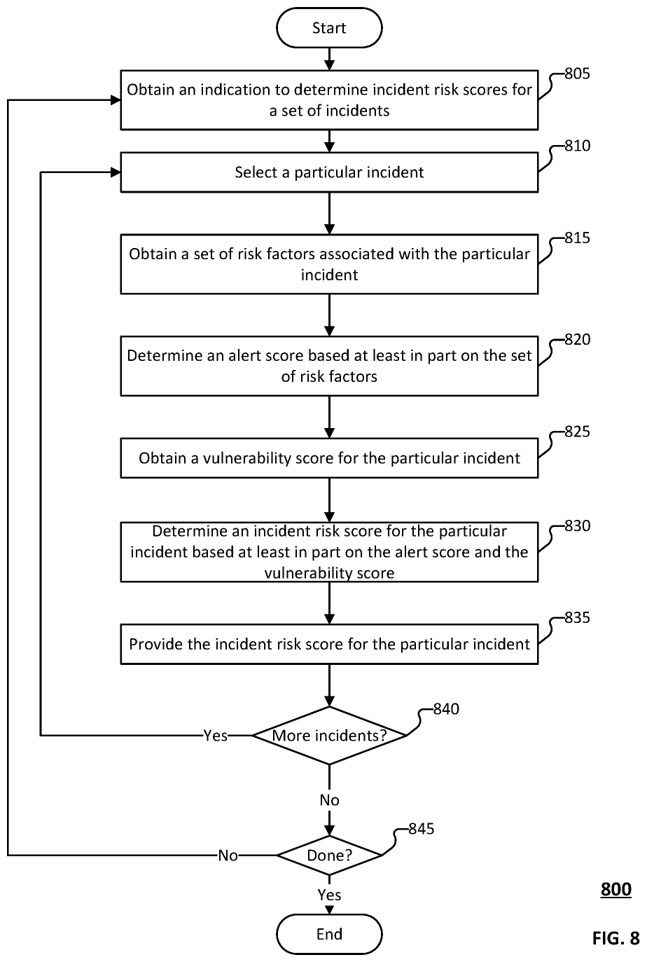

FIG. 8 is a flow diagram of a method for determining an incident risk score for a set of incidents according to various embodiments. In various embodiments, process 800 is implemented at least in part by system 100 of FIG. 1 and/or system 200 of FIG. 2.

In some implementations, process 800 may be implemented by one or more servers, such as in connection with providing a service to a network (e.g., a security entity and/or a network endpoint such as a client device). In some implementations, process 800 may be implemented by a security service that analyzes the security posture of a network such as attack surface vulnerabilities, or provides an assessment of the attack surface such as based on computing a security rating for an attack surface and/or configuring and providing a user interface that provides the security rating or a visualization of the security rating or attack surface.

In some embodiments, process 800 is invoked by a system or service in order to determine the incident risk scores for a set of incidents associated with an attack surface. The system determines the incident risk scores in connection with determining or updating the security rating for the attack surface. As an example, process 800 can be invoked by 610 of process 600.

At 805, the system obtains an indication to determine incident risk scores for a set of incidents. For example, the set of incidents are the identified incidents for the attack surface. The determination of the incident risk scores may be invoked by a request to determine a security rating or to provide the security rating to another system (e.g., via a user interface).

At 810, the system selects a particular incident. The system can select the particular incident in connection with iterating over 810-840 to compute the incident risk score for each incident in the set of incidents for the attack surface.

At 815, the system obtains a set of risk factors associated with the particular incident.

In some embodiments, the system can determine the set of risk factors for the particular incident based at least in part on querying a mapping of one or more incident characteristics to risk factors. As an example, the system queries a mapping of incident types to risk factors to determine the risk factors associated with the particular incident. As another example, the system queries a mapping of device types to risk factors based on a device from which the incident arises.

In some embodiments, the system determines the set of risk factors associated with the particular incident by iteratively analyzing the incident against each of a predefined set of risk factors to identify those set of risk factors that are characteristic of the incident.

Examples of risk factors that can be used to characterize an incident include (a) a critical system (e.g., the system subject to the vulnerability is identified as critical), (b) an end-of-life system, (c) an exposed login (e.g., the vulnerability comprises an exposed login), (e) informational (e.g., a product that is not found to be inherently risky), (f) an IoT system (e.g., the device/system subject to the vulnerability is an IoT system), (g) a misconfiguration, (h) a lack of cryptography, (i) a potential data loss, (j) a privileged access, (k) a remote access, (l) a vulnerable product/service/protocol, (m) a weak cryptography (e.g., a product/service that implements a cryptography that is easy to exploit).

At 820, the system determines an alert score based at least in part on the set of risk factors. In some embodiments, risk factors have corresponding risk score impact values and the risk score impact values for the risk of factors is used to compute the alert score. As an example, the alert score is an average value of the risk score impact values for set the risk of factors. As another example, the alert score is the sum of the risk score impact values for the risk of factors associated with the particular incident.

At 825, the system obtains a vulnerability score for the particular incident. In some embodiments, the vulnerability score is determined based at least in part on one or more of (a) a CVSS score, (b) an EPSS score, and (c) exploit intelligence score.

The exploit intelligence score is determined based at least in part on exploit information associated with the particular incident. Examples of the exploit information include (i) an indication that the exploit is implemented in the wild, (ii) an exploit maturity (e.g., has the exploit been weaponized, discovered, published, etc.), (iii) an indication that the exploit has been exploited within a first predefined period of time (e.g., within the last month), (iv) an indication that the exploit has been exploited within a second predefined period of time (e.g., within the last two years), etc. Various other types of information for the exploit may be collected and used in connection with determining the vulnerability score. The exploit intelligence score may be a determined according to a predefined exploit intelligence function. As an example, the predefined exploit intelligence function determines an aggregate score of the types of exploit information (e.g., a sum of the scores for the various exploit information collected). As another example, the predefined exploit intelligence function determines an average score among the types of exploit information.

The vulnerability score is determined according to a predefined function. As an example, the predefined function determines a sum of two or more of (a) the CVSS score, (b) the EPSS score, and (c) the exploit intelligence score. As another example, the predefined function determines an average score among (a) the CVSS score, (b) the EPSS score, and (c) the exploit intelligence score.

At 830, the system determines an incident risk score for the particular incident based at least in part on the alert score and the vulnerability score. In some embodiments, the system computes the incident risk based at least in part on Equation (1). However, various other predefined functions may be implemented to determine the incident risk score based at least in part on the alert score and the vulnerability score. For example, the system determines the sum of (a) a sum of the alert scores for the various risk factors invoked and (b) a vulnerability score.

At 835, the system provides the incident risk score for the particular incident. In some embodiments, the system provides the incident risk score to the system, service, or other process that invoked process 800.

At 840, the system determines whether more incidents are to be analyzed. In response to determining that more incidents are to be analyzed at 840, process 800 returns to 810 and process 800 iterates over 810-840 until no further incidents are to be analyzed.

At 845, a determination is made as to whether process 800 is complete. In some embodiments, process 800 is determined to be complete in response to a determination that no further security ratings are to be determined/provided, no further attack surfaces are to be evaluated, no further incident risk scores are to be determined, a particular attack surface has no further medium or high severity risks, an administrator indicates that process 800 is to be paused or stopped, etc. In response to a determination that process 800 is complete, process 800 ends. In response to a determination that process 800 is not complete, process 800 returns to 805.

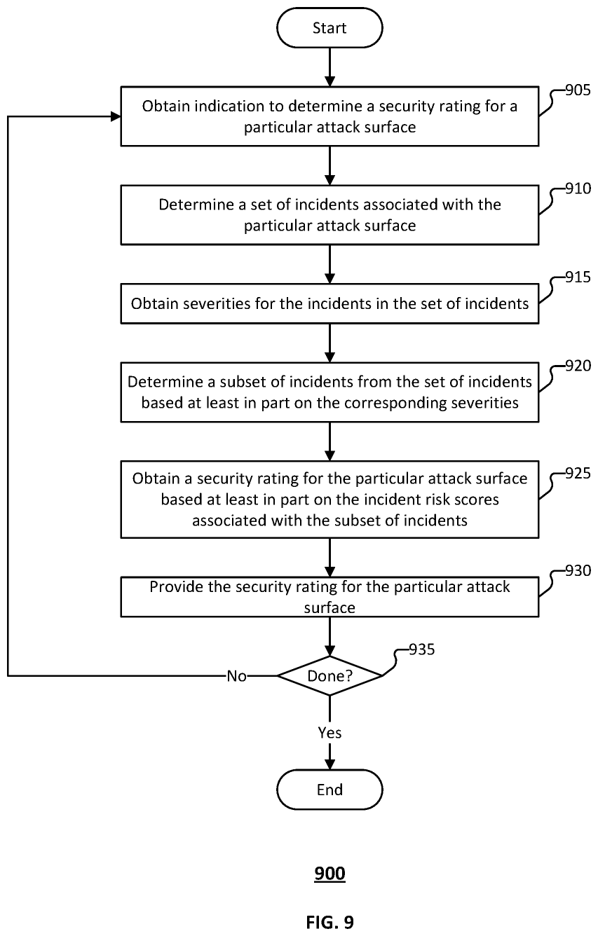

FIG. 9 is a flow diagram of a method for obtaining a security rating for a particular attack surface according to various embodiments. In various embodiments, process 900 is implemented at least in part by system 100 of FIG. 1 and/or system 200 of FIG. 2.

In some implementations, process 900 may be implemented by one or more servers, such as in connection with providing a service to a network (e.g., a security entity and/or a network endpoint such as a client device). In some implementations, process 900 may be implemented by a security service that analyzes the security posture of a network such as attack surface vulnerabilities, or provides an assessment of the attack surface such as based on computing a security rating for an attack surface and/or configuring and providing a user interface that provides the security rating or a visualization of the security rating or attack surface.

In some embodiments, process 900 is invoked by a system or service in order to determine the security rating for an attack surface comprising a set of incidents. The system determines the security rating in connection with configuring or updating a user interface that provides security information for an attack surface, or in connection with benchmarking a first attack surface against a set of other attack surfaces.

At 905, the system obtains indication to determine a security rating for a particular attack surface. In some embodiments, the indication to determine the security rating is invoked in response to a system, service, or other process receiving a request to provide the security rating for a network, such as to provide a dashboard or other user interface comprising vulnerability or security information pertaining to the network. In some embodiments, the indication to determine the security rating is invoked in response to a system, service, or other process receiving a request to perform a benchmarking of a plurality of attack surfaces.

At 910, the system determines a set of incidents associated with the particular attack surface.

At 915, the system obtains severities for the incidents in the set of incidents. In some embodiments, the system determines the severities for the incidents based at least in part on computing the respective incident risk scores for the set of incidents. For example, the system invokes process 800 to obtain the severities for the incidents in the set of incidents.

Various weighting functions may be implemented to prioritize the set of incidents. The system assigns weightings for the set of incidents so that the security rating is sensitive to the most serious/severe incidents. In some embodiments, the weighting function is selected to distribute at least ninety percent (90%) of the collective weightings to the top fifty percent (50%) of most severe incidents (e.g., the half of set of incidents having a highest incident risk score). Based on the weighting according to the weight function (e.g., the weighting function of Equation 3), a serious incident has a disproportionately large impact on the security rating. For example, if an attack network has a single extremely severe incident and a set of relatively low severity incidents, the security rating is computed/configured to reflect the extremely severe incident.

At 920, the system determines a subset of incidents from the set of incidents based at least in part on the corresponding severities. In some embodiments, the subset of incidents corresponds to the most severe incidents. The most severe incidents may comprise the high and medium severity incidents (e.g., attack surface rules). As an example, the system excludes low-severity incidents from the computation of the security rating (e.g., the low-severity incidents do not contribute to the security rating).

An incident may be classified as low-severity, medium-severity, or high severity based at least in part on the corresponding incident risk scores. For example, the system queries a mapping of incident risk score ranges to severity levels.

In some embodiments, the system determines the security rating based on at least subset of the set of incidents associated with an attack surface for a network. The system can use an N most severe incidents (e.g., incidents having a highest incident risk score) of M incidents associated with the attack surface to determine the security rating and exclude from the computation of the security rating those M-N incidents that are least severe. N and M are positive integers. Additionally, or alternatively, the system determines the subset of incidents having incident risk scores that exceed a predefined risk score threshold, and computes the security rating based at least in part on the subset of incidents. The remaining incidents of the set of incidents (e.g., those incidents having corresponding incident risk scores less than the predefined risk score threshold) are excluded (e.g., not considered) in the computation of the security rating.

At 925, the system obtains a security rating for the particular attack surface based at least in part on the incident risk scores associated with the subset of incidents. The system can compute the security rating based at least in part on computing a score according to Equation (5).

At 930, the system provides the security rating for the particular attack surface. In some embodiments, the system provides security rating to the system, service, or other process that invoked process 900. As an example, the system provides the security rating to a user interface (e.g., to a service that is configuring the user interface to display the security rating). As another example, the system provides the security rating to a service computing a benchmarking of a first attack surface against a set of other attack surfaces.

At 935, a determination is made as to whether process 900 is complete. In some embodiments, process 900 is determined to be complete in response to a determination that no further security ratings are to be determined/provided, no further attack surfaces are to be evaluated, no further incident risk scores are to be determined, a particular attack surface has no further medium or high severity risks, an administrator indicates that process 900 is to be paused or stopped, etc. In response to a determination that process 900 is complete, process 900 ends. In response to a determination that process 900 is not complete, process 900 returns to 905.

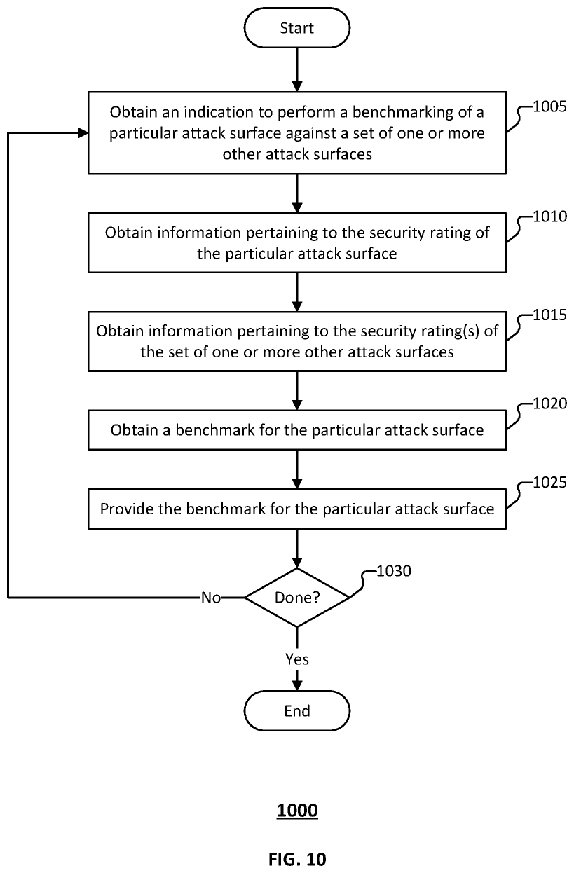

FIG. 10 is a flow diagram of a method for evaluating a security rating for a particular attack surface according to various embodiments. In various embodiments, process 1000 is implemented at least in part by system 100 of FIG. 1 and/or system 200 of FIG. 2.

In some implementations, process 1000 may be implemented by one or more servers, such as in connection with providing a service to a network (e.g., a security entity and/or a network endpoint such as a client device). In some implementations, process 1000 may be implemented by a security service that analyzes the security posture of a network such as attack surface vulnerabilities, or provides an assessment of the attack surface such as based on computing a security rating for an attack surface and/or configuring and providing a user interface that provides the security rating or a visualization of the security rating or attack surface.

In some embodiments, process 1000 is invoked by a system or service to obtain a benchmarking of a particular attack surface against a set of other attack surfaces.

At 1005, the system obtains an indication to perform a benchmarking of a particular attack surface against a set of one or more other attack surfaces. The indication to perform the benchmarking may be invoked by a service or process that configures a user interface to present security information for the particular attack surface, or based on selection by a user of a selectable element (e.g., a button) to request a benchmarking of the particular attack surface.

At 1010, the system obtains information pertaining to the security rating of the particular attack surface. In some embodiments, the information pertaining to the security rating is obtained by invoking process 900. If the security rating has already been computed (e.g., and the vulnerabilities for the attack surface have not changed since the computation), the system may retrieve the security rating from storage.

At 1015, the system obtains information pertaining to the security rating(s) of the set of one or more other attack surfaces. In some embodiments, the information pertaining to the security rating of the set of one or more other attack surfaces is obtained by invoking process 900. The one or more other attack surfaces may include peer networks, networks/attack surfaces for a particular industry, networks/attack surfaces for a particular geography, etc. In some embodiments, the one or more other attack surfaces are selected/defined by a user (e.g., a user requesting its organization's attack surface to be benchmarked against other attack surfaces).

At 1020, the system obtains a benchmark for the particular attack surface. The system compares the security rating for the particular attack surfaces with the security ratings for the set of one or more other attack surfaces to obtain the benchmark.

At 1025, the system provides the benchmark for the particular attack surface. In some embodiments, the system provides security rating to the system, service, or other process that invoked process 1000. As an example, the system provides the security rating to a user interface (e.g., to a service that is configuring the user interface to display the security rating for the particular attack surface or the benchmarking of the particular attack surface against other attack surfaces).

At 1030, a determination is made as to whether process 1000 is complete. In some embodiments, process 1000 is determined to be complete in response to a determination that no further security ratings are to be determined/provided, no further attack surfaces are to be evaluated, no further attack surfaces are to be compared or benchmarked, a particular attack surface has no further medium or high severity risks, an administrator indicates that process 1000 is to be paused or stopped, etc. In response to a determination that process 1000 is complete, process 1000 ends. In response to a determination that process 1000 is not complete, process 1000 returns to 1005.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for identifying network incident risk, comprising:
one or more processors configured to:
determine a set of incident risk scores for a set of incidents on a network;
generate a security rating for an attack surface for the network, wherein the security rating is an aggregation of the incident risk scores associated with a subset of risks on the network; and
provide the security rating; and
a memory coupled to the one or more processors and configured to provide the one or more processors with instructions.

2. The system of claim 1, wherein providing the security rating comprises providing the security rating to a service that is configured to automatically perform a remediation of one or more issues contributing to the security rating.

3. The system of claim 1, wherein the one or more processors are further configured to:
generate instructions for performing a remediation of one or more issues contributing to the security rating.

4. The system of claim 1, wherein the security rating is dynamic and is recalculated when an incident risk score for an underlying risk changes.

5. The system of claim 1, wherein the incident risk score for the underlying risk changes in response to a change to a risk property.

6. The system of claim 1, wherein the one or more processors are further configured to:
obtain information pertaining to a set of risk properties for a network or services consumed or provided within the network, wherein the set of risk properties comprises the underlying risk property; and
determine that the underlying risk property has changed; and
in response to determining that the underlying risk has changed, recomputing the security rating.

7. The system of claim 1, wherein one or more of the set of incident risk scores is periodically recalculated.

8. The system of claim 1, wherein the security rating is calculated as a weighted average of the incident risk scores of a set of incidents that would result from an enablement of all high and medium-severity attack surface rules on an attack surface for the network.

9. The system of claim 8, wherein a predefined percentage of the set of incidents having a highest incident risk scores are disproportionally weighted more heavily than other incidents comprised in the set of incidents.

10. The system of claim 8, wherein low-severity policies are excluded from calculation of the security rating.

11. The system of claim 1, wherein the security rating is normalized across attack surfaces for a set of networks.

12. The system of claim 11, wherein the one or more processors are further configured to:
determine a benchmarking of the attack surface for the network based on normalized security ratings across the attack surfaces for the set of networks; and
provide an indication of a benchmark for the security rating of the attack surface for the network.

13. The system of claim 12, wherein the benchmarking is determined with respect to attack surfaces across a selected industry segment.

14. The system of claim 1, wherein the security rating represents an adversarial view of an external-facing attack surface of the network.

15. The system of claim 1, wherein the one or more processors are further configured to:
generate a graphical visualization of the security rating.

16. The system of claim 15, wherein the graphical visualization comprises security ratings of attack surfaces for the network based on geography.

17. The system of claim 1, wherein the one or more processors are further configured to:
determine whether the security rating exceeds a predefined threshold; and
in response to determining that the security rating exceeds the predefined threshold, causing an active measure to be performed.

18. The system of claim 17, wherein the active measure comprises one or more of: (i) triggering a playbook, (ii) generating an alert, and (iii) causing a remediation action to be performed with respect to a particular vulnerability.

19. The system of claim 1, wherein the security rating is decomposable into a set of network components that contributed to the computed security rating.

20. The system of claim 19, wherein the one or more processors are further configured to:
configure a user interface based at least in part on the security rating, the user interface comprising a selectable element; and
in response to determining that the selectable element is selected, providing an indication of the set of network components that contributed to the security rating.

21. The system of claim 1, wherein the security rating aggregates scores for risks associated with a set of one or more of incidents, common vulnerabilities and exposures (CVEs), and misconfigurations.

22. The system of claim 1, wherein the network comprises one or more of a service, a cloud-based service, a node, a security entity, a network-connected device, a client system, or a website.

23. The system of claim 1, wherein an incident risk score for a particular incident on the network is determined using a combination of various data sources, including expert domain knowledge, commercial and reputable open-source threat and exploit intelligence relevant to the CVEs on the network.

24. The system of claim 1, wherein an incident risk score for a particular incident on the network is determined using a machine learning model or artificial intelligence process.

25. The system of claim 24, wherein the machine learning model is trained using one or more of expert domain knowledge, commercial and reputable open-source threat and exploit intelligence relevant to the CVEs on the network.

26. The system of claim 1, wherein the one or more processors are further configured to:
causing a remediation of one or more issues contributing to the security rating to be performed according to a prioritization of risks, wherein the prioritization is determined based at least in part on corresponding security ratings.

27. A method for identifying network incident risk, comprising:
determining a set of incident scores for a set of incidents on a network;
generating a security rating for an attack surface for the network, wherein the security rating is an aggregation of the incident risk scores associated with a subset of risks on the network; and
providing the security rating.

28. A computer program product embodied in a non-transitory computer readable medium for identifying network incident risk, and the computer program product comprising computer instructions for:
determining a set of incident scores for a set of incidents on a network;
generating a security rating for an attack surface for the network, wherein the security rating is an aggregation of the incident risk scores associated with a subset of risks on the network; and
providing the security rating.
